(19) United States
(12) Patent Application Publication
(10) Pub. No.: US 2007/0014327 A1
(43) Pub. Date: Jan. 18, 2007

(54) Integrated Time and Temperature Management Device

(76) Inventor: Norman A. Faiola, Ithaca, NY (US)

Correspondence Address: BOND, SCHOENECK & KING, PLLC, ONE LINCOLN CENTER, SYRACUSE, NY, 13202-1355, US

(21) Appl. No.: 11/456,668

(22) Filed: Jul. 11, 2006

Related U.S. Application Data
(60) Provisional application No. 60/595,550, filed on Jul. 14, 2005.

(51) Int. Cl. G01K 3/00

(52) U.S. Cl. 374/102

(57) ABSTRACT

The invention is an integrated, multi-function, portable, battery powered device for performing the following functions: measuring and displaying at least one temperature of at least one object or substance; visually displaying the current time; setting at least one selectable amount of elapsed time, counting cumulatively forward from the moment of setting or counting down the time remaining from the moment of setting until a selected future moment of interest; visually and/or audibly indicating the state of the selected elapsing time including the expiration thereof; visually indicating the amount of expected battery life remaining; encasing the temperature-sensing means when inactive for protection, cleanliness and safety; securely affixing the invention to a user's pocket or clothing such that at least one means of display is readable by the user at all times; and conveniently changing the battery when necessary.

### PRIORITY CLAIM

The present application claims priority to U.S. Provisional Application Ser. No. 60/595,550, filed Jul. 14, 2005.

### BACKGROUND OF THE INVENTION

The invention relates generally to apparatus for sensing and reporting temperatures in relevant and selectable time domains. More specifically, the invention relates to a device for sensing and reporting temperatures at times and intervals appropriate for a particular contextual regimen, as for example, without limitation, safe food preparation and storage.

### RELATED ART

Battery-powered portable thermometers with means of displaying sensed temperature are well known in the art. Similarly, battery-powered portable clocks and timers with means of displaying time and elapsed time and selectably signaling the user with audible alarms are well known in the art. What is novel and non-obvious in the current invention is the convenient and complementary integration of the functions enumerated in the current invention, usefully eliminating the need for using and coordinating multiple time and temperature devices.

Given HACCP (Hazard Analysis and Critical Control Point) regulations in food service environments today, food service workers must frequently monitor the temperatures of multiple food substances at various states including preparation, cooking and storage. Each of these states requires temperature measurement at different times and intervals appropriate for the given food substance and state. This requires food service workers to remember these multiple and overlapping times and time intervals in order to take temperature measurements appropriately. Additionally, foodservice workers are encouraged to wash their hands frequently, as often as needed but not less often than intervals specified by their employers. The hectic pace of foodservice operations and all these burdens on foodservice workers' memories commonly lead to memory lapses that compromise the proper temperature regimen and hand-washing required for safe food preparation, cooking and storage.

Keeping track of time is made more difficult for foodservice workers by the fact that they are discouraged from wearing watches, since watches are difficult to keep clean and may cause food contamination. Using a wall clock avoids contamination but is inconvenient for foodservice workers who often move around and may not always be able to see a clock. Further, wall clocks cannot conveniently provide each worker with multiple alarm functions needed for that worker's particular needs.

What is needed is a hygienic portable device for each worker that selectably supports that worker's particular regime throughout the workday, reducing the burden on the foodservice worker's memory and increasing the fidelity of the food safety regimen. The disclosed invention meets this need in a convenient and useful way.

It is therefore a principal object and advantage of the preset invention to provide a convenient and complementary integration of the functions enumerated in the current invention, usefully eliminating the need for using and coordinating multiple time and temperature devices. Other objects and advantages of the present invention will in part be obvious, and in part appear hereinafter.

### SUMMARY OF THE INVENTION

In accordance with the foregoing objects and advantages, the present invention provides an integrated time and temperature sensing device. The device essentially comprises a temperature probe having first and second ends; a temperature sensing element attached to the first end; and a display device housing attached to the second end. The display device housing houses temperature display circuitry operably associated with the temperature sensing element and which is adapted to provide notification of temperature; time display circuitry adapted to provide notification of the current time; first timer circuitry for actuating a timer of first predetermined duration; and an alarm automatically actuable at the conclusion of said first predetermined duration.

### BRIEF DESCRIPTION OF THE DRAWINGS

FIG. 1 is a partially exploded, front perspective view of the present invention with the invention's protective sleeve removed for clarity.

FIG. 2 is a rear perspective view of the present invention.

### DETAILED DESCRIPTION

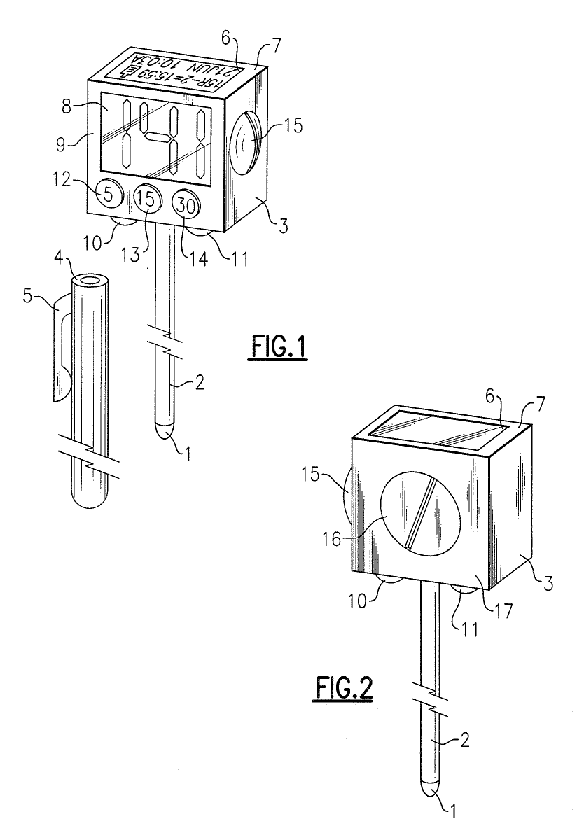

In FIG. 1, the invention's temperature sensing element 1, in the preferred embodiment comprising an encased direct current thermistor, is fixed so as to hermetically seal the distal end of a tubular probe 2, in the preferred embodiment such probe comprising a stainless steel tube. The tubular probe 2 is attached at its proximal end to a cube-shaped main housing 3 and such probe 2 houses wires from the sensing element 1 to electronic circuitry (not shown) contained inside the main housing 3. Main housing 3 is intended to be held manually by the user when taking temperatures with its display surfaces visible to the user even when the invention is affixed to user's clothing or clipboard. In the preferred embodiment main housing 3 is comprised of a hermetically sealed hollow plastic enclosure.

A removable protective sleeve 4 comprising a closed distal end covers the probe 2 when the invention is not measuring temperature. In the preferred embodiment, this sleeve 4 is plastic and comprises at least one integral means, such as a clip 5, for attaching to the user's clothing or clipboard. The sleeve 4 would ordinarily remain affixed to user's clothing or clipboard regardless of whether it is housing the rest of the invention.

The main housing 3 comprises a means of visual display of temporal temperature information on at least one face and in the preferred embodiment comprises a liquid crystal display 6 on its upper surface 7 so as to be easily read by the user while the invention is in a chest or sleeve pocket without the need to manipulate the invention manually. Additionally, in the preferred embodiment, the main housing 3 comprises a second liquid crystal display 8 on the front surface 9, such second display 8 having means to display information not displayed on the first display or, alternatively, displaying the same information in a larger format that is easy to read from a distance, such as arm's length, when temperatures are being measured.

Further, the main housing 3 comprises a means of setting the current time which in the preferred embodiment is comprised of two hermetically sealed buttons, one each for the hour 10 and for the minutes 11. Once the user sets the current time, the invention's electronic circuitry immediately and automatically displays a message on at least one display 6 requesting the user to select the time interval in minutes between audible and/or visual remindersm, for example, for the user to wash his hands. Once this time interval is set, audible and/or visible (e.g., hand-washing) reminders will be given at the selected interval indefinitely without further action on the user's part. Such audible and/or visual reminders will be given very briefly by the invention using distinctive audible tones and/or visual cues and will not require the user to turn off the reminder.

Alternatively, in lieu of the user setting the current time and date for the invention using buttons 10 and 11, the invention's electronic circuitry may incorporate circuitry which is well known in the art for receiving by wireless signals an external timing reference from the National Institute of Standards and Technology (NIST), the US Naval Observatory or the like. In such embodiment, buttons 10 and 11 would not be necessary and the device would initialize and sustain its current-time keeping from the moment of installing the battery (not shown) in the battery receptacle 16 shown in FIG. 2 on the back surface of the invention 17.

Additionally, the main housing 3 comprises means for selectably setting at least one timer for at least one task (e.g., one that is not hand-washing). In the preferred embodiment this means is comprised of three hermetically sealed buttons, each having a fixed time interval associated with it such as a five-minute interval button 12, a fifteen-minute interval button 13, and a thirty-minute interval button 14. The user may depress the button corresponding to the desired reminder time interval and, if there is no other reminder currently using that time interval, will see on the visual display 6 a message assigning a first unique reminder identifier and the time remaining in the chosen interval. In the preferred embodiment and in the case of a fifteen minute reminder the visual display 6 would display such first unique reminder identifier and time remaining as “15R-1=15:00” and one second later would index the display to “15R-1=14:49” and so on counting down until the set interval expired and the audio/visual alarms were given.

If the user depresses a button corresponding to the desired reminder time interval and there is another previous reminder currently using that same time interval, the user will see on the visual display 6 that the invention has assigned the new reminder with a second unique reminder identifier, an example in a preferred embodiment being “15R-2>15:00”. It is thus possible with the invention to have multiple reminders set within each of the five-minute, fifteen-minute and thirty-minute intervals. The user has only to remember which unique reminder identifier is associated with which physical activity to be performed.

Upon the expiration of a reminder interval, the visual display 6 flashes the unique reminder identifier for a brief period so the user may readily know which of the extant reminders expired, or otherwise provides an “alarm”. Immediately thereafter, that uniquely-identified reminder is erased and only the remaining unexpired reminders are available for display. In the event that all reminders expire, the invention resets the next unique identifier number back to “1” and increments therefrom. Otherwise, each new identifier simply increments to the next higher number above the last-issued identifier.

The current time of day and date is always displayed on at least one part of one visual display 6. Additionally, the current power state of the internal battery (not shown) is always visually displayed, preferentially with a battery icon customary for such purposes. So long as there are any extant reminders, the visual display 6 also automatically and continuously scrolls and displays the associated unique identifiers and their remaining time in sequence, preferentially in order of least-time-remaining. The cycle time associated with the display of a particular reminder may be a fixed time or may be automatically and proportionally reduced to allow all extant reminders to be viewed in a conveniently short time.

When the user wishes to measure the temperature of an object or substance, either as a result of a reminder alarm or independently, the user simply removes the invention from its protective sleeve 4 and presses the temperature sensing element 1 against or into the object or substance. The user then continuously depresses the temperature button 15 while observing at least one of the visual displays 6. At least one of the visual displays 6 will display temperature values in either or both Fahrenheit and Celsius scales so long as the button 15 is depressed. In the preferred embodiment, the electronic circuitry displays incrementing temperature values until reaching the actual temperature, at which point the displayed temperature data remains constant. Releasing the button 15 will discontinue temperature sensing and temperature data display.

The invention's electronic circuitry comprises circuitry that is well known in the art for centrally processing signals from the sensing element 1, for processing user inputs buttons 10, 11, 12, 13, 14, 15, for processing current time and elapsed time and for driving the visual display(s) of resulting data and for emitting various audible signals.

The invention is waterproof and cleanable with common foodservice cleaning chemistry.

What is claimed is:

1. An integrated time and temperature sensing device, comprising:
a) a temperature probe having first and second ends;
b) a temperature sensing element attached to said first end; and
c) a display device housing attached to said second end, said display device housing comprising:
i) temperature display circuitry operably associated with said temperature sensing element and adapted to provide notification of temperature;
ii) time display circuitry adapted to provide notification of the current time;
iii) first timer circuitry for actuating a timer of first predetermined duration; and
iv) an alarm automatically actuable at the conclusion of said first predetermined duration.

2. The integrated time and temperature sensing device according to claim 1, wherein said display device housing further comprises second timer circuitry for actuating a second timer of second predetermined duration.

3. The integrated time and temperature sensing device according to claim 2, wherein said second predetermined duration is 15 minutes.

4. The integrated time and temperature sensing device according to claim 2, wherein said second time circuiting is adopted to actuate a plurality of timers, each of said second predetermined duration.

5. The integrated time and temperature sensing device according to claim 2, wherein said display device housing further comprises third timer circuitry for actuating a third timer of third predetermined duration.

6. The integrated time and temperature sensing device according to claim 5, wherein said third predetermined duration is 30 minutes.

7. The integrated time and temperature sensing device according to claim 5, wherein said third timer circuitry is adapted to actuate a plurality of timers, each said third predetermined durations.

8. The integrated time and temperature sensing device according to claim 1, wherein said first predetermined duration is 5 minutes.

9. The integrated time and temperature sensing device according to claim 1, wherein said first timer circuitry is adapted to actuate a plurality of timers, each of said first predetermined duration.

10. The integrated time and temperature sensing device according to claim 1, wherein said display device housing further comprises a first source on which a first display is contained.

11. The integrated time and temperature sensing device according to claim 10, wherein said temperature display circuitry is adapted to display said temperature on said first display.

12. The integrated time and temperature sensing device according to claim 10, wherein said display device housing further comprises a second surface on which a second display is contained.

13. The integrated time and temperature sensing device according to claim 12, wherein said time display circuitry is adapted to display said current time on said second display surface.

14. The integrated time and temperature sensing device according to claim 1, wherein said display device housing further comprises a user accessible temperature sensor actuator positioned thereon.

15. The integrated time and temperature sensing device according to claim 14, wherein said temperature sensor actuator is a button.

16. The integrated time and temperature sensing device according to claim 1, wherein said display device housing further comprises a user accessible time setting mechanism positioned thereon.

17. The integrated time and temperature sensing device according to claim 16, wherein said time setting mechanism comprises first and second button for setting hours and minutes, respectively.

18. The integrated time and temperature sensing device according to claim 16, further comprising means for wirelessly receiving time data from a transmitting source.

19. The integrated time and temperature sensing device according to claim 1, wherein said display device housing is cube-shaped.

20. The integrated time and temperature sensing device according to claim 1, further comprising a sleeve removably attached in covering relation to said temperature probe.
